(19) United States
(12) Patent Application Publication
(10) Pub. No.: US 2015/0138107 A1
(43) Pub. Date: May 21, 2015

(54) ELECTRONIC DEVICE AND METHOD FOR OUTPUTTING DETECTED INFORMATION

(71) Applicant: SHARP KABUSHIKI KAISHA, Osaka -shi, Osaka (JP)

(72) Inventors: Kenichi Horiuchi, Osaka-shi (JP); Youhei Satou, Osaka-shi (JP)

(73) Assignee: SHARP KABUSHIKI KAISHA, Osaka-shi, Osaka (JP)

(21) Appl. No.: 14/402,204

(22) PCT Filed: May 21, 2013
(86) PCT No.: PCT/JP2013/064093

§ 371 Date: Nov. 19, 2014

(30) Foreign Application Priority Data
May 28, 2012 (JP) 2012-121251

(51) Int. Cl. G06F 1/32; G06F 3/041

(52) U.S. Cl. CPC G06F 1/3259; G06F 3/0416
USPC 345/173

(57) ABSTRACT

Provided is an electronic device having a position detection function, the electronic device being capable of reducing consumption of electric current without losing operability. A detected information output section (5) (i) temporarily retains first detected information selected from detected information in accordance with control of a timing control section, and (ii) sequentially outputs, at a second cycle which is larger than a first cycle, a detected information group having the first detected information and second detected information selected from the detected information other than the first detected information.

### TECHNICAL FIELD

The present invention relates to an electronic device having a position detection function such as a touch panel.

### BACKGROUND ART

Mobile electronic devices are driven by mainly an electric power supplied from batteries, and reduction in consumption of electric current is an important object to enable use of the mobile electronic devices for a long time. Therefore, there has been tried to reduce consumption of electric current in such a mobile electronic device.

For example, Patent Literature 1 discloses a mobile image display device capable of improving flexibility of display while reducing consumption of electric current.

The mobile image display device of Patent Literature 1 includes a plurality of self-luminous pixels, and, among the plurality of pixels, display pixels actually used to display an image can be changed by a display control section. The number of pixels used in a power-saving mode is set to be less than the number of pixels used in a non-power-saving mode.

By thinning the number of pixels used to display an image as necessary as described above, an electric power is not supplied to pixels which are not used to display the image. This can reduce consumption of electric current.

Patent Literature 2 discloses a replay device which (i) calculates the number of thinned frames on the basis of a remaining battery power and information on a streaming image to be processed and (ii) does not perform decoding of encoded frames corresponding to the thinned frames.

The replay device of Patent Literature 2 can reduce an error of a reduction amount of frames, as compared to a case where the number of thinned frames are calculated only on the basis of a remaining battery power. This can improve an image quality of moving images obtained by decoding.

There are also spread mobile electronic devices each including a touch panel module which has a position detection function on a display screen of a display device so that a user can directly operate the display screen by touching his/her finger or the like.

In such an electronic device, input operations (events) by a finger of a user are sequentially detected by the touch panel module, and touch events (detected information) obtained on the basis of the input operations are sequentially (at any time) notified to an application (application software).

Here, each touch event has information such as a position of coordinates of a finger as a detection object on a detection surface of the touch panel module, a pressure to the detection surface, and an area and a time in contact with the detection surface.

By sequentially notifying the touch events to the application, the application sequentially processes the touch events (draws and updates) and recognizes the input operations by the finger of the user. Therefore, the application can perform processing in response to the input operations by the user.

Even if the user performs an incorrect (unclear) input operation (gesture) on the touch panel module, it is possible to realize an intuitive user interface by recognizing the gesture in a moment. In order to realize the gesture, an attempt has been made to improve a drawing update cycle, at which the application updates drawing, by improving a cycle of notifying a touch event to the application.

However, without exception, a mobile electronic device including a touch panel module is also demanded to be used for a long time after charging, so that reduction in consumption of electric current is a huge problem.

Therefore, in a mobile electronic device including a touch panel module, a touch event notification cycle to the application is tried to be reduced, to thereby reduce a touch event notification frequency in order to reduce consumption of electric current at the sacrifice of usability.

Note that it is well known that, although notification of a touch event to the application itself does not affect consumption of electric current so much, the consumption of electric current is increased when, in response to the touch event, the application performs a drawing update process.

In a general electronic device, touch events are sequentially notified to an application at a cycle of 1/60 sec. On the contrary, in a conventional electronic device in which consumption of electric current is reduced, touch events are sequentially notified at a cycle of 1/30 sec.

FIG. 7 is a view illustrating a flow in which information on an input operation by a user, which has been detected in a touch panel module in a conventional electronic device, is notified to an application. A vertical axis indicates time.

As illustrated in FIG. 7, information on an input operation by a user on a surface of a touch panel is sequentially taken out as scan information by a touch farm, and touch events are sequentially notified to the application via a touch driver and a framework.

Coordinate information, which is information on a position of coordinates of a finger on the surface of the touch panel, is sequentially inputted to the touch driver. At this time, the touch driver thins the coordinate information every two pieces of the coordinate information, which results in reduction in the number of touch events outputted by the framework per unit time. That is, a cycle of inputting the touch events to the application is increased.

Accordingly, a frequency at which the application performs a drawing update process is decreased. This makes it possible to reduce consumption of electric current.

Although not shown, a cycle of notifying a touch event to the application can be increased by a method of thinning scan information by controlling a cycle at which the scan information is obtained in the touch farm.

### CITATION LIST

### Patent Literatures

Patent Literature 1
Japanese Patent Application Publication, Tokukai, No. 2004-012655 (Publication date: Jan. 15, 2004)

Patent Literature 2
Japanese Patent Application Publication, Tokukai, No. 2012-278429 (Publication date: Jan. 20, 2012)

### SUMMARY OF INVENTION

### Technical Problem

Although the conventional electronic device described above reduces the consumption of electric current, the number of touch events notified to the application per unit time is also reduced. Therefore, an amount of information that the application obtains is reduced, which results in decrease in operability of the electronic device.

FIG. 8 is a view illustrating a touch event notified in response to an input operation by a user. (a) of FIG. 8 illustrates a FIG. 20 as the input operation to a detection surface 2 of a touch panel module, (b) of FIG. 8 illustrates, on a two-dimensional plane, touch events which have been notified to the application at a cycle of 1/60 sec. in response to the input operation of (a) of FIG. 8, and (c) of FIG. 8 illustrates, on a two-dimensional plane, touch events which have been notified to the application at a cycle of 1/30 sec. in response to the input operation of (a) of FIG. 8.

In accordance with the FIG. 20 shown in (a) of FIG. 8 which is drawn by the user on the detection surface 2, the touch event is notified to the application at a cycle of 1/60 sec. Therefore, the application sequentially obtains touch events 24 forming a curve as shown in (b) of FIG. 8. Note that a touch event indicating a touch-down is denoted by 21.

On the contrary, in a case where a touch event is notified to the application at a cycle of 1/30 sec., the application sequentially obtains touch events 25 forming a curve as shown in (c) of FIG. 8.

Notification of touch events to the application at a cycle of 1/30 sec. reduces an amount of information of the touch events for use in recognition of an input operation by a user. Therefore, a locus of a finger cannot be notified clearly as shown in (c) of FIG. 8, as compared with a locus in (b) of FIG. 8.

The application cannot recognize (draw) a locus of a finger when a frequency at which a touch event is notified is decreased as described above. In particular, for example, when the finger moves at a high speed, the application cannot recognize a motion of the finger and therefore cannot correctly recognize an input operation by a user.

It is also impossible to correctly recognize a moving speed and acceleration of a finger of a user when it is moved.

Therefore, there is a problem in that, although consumption of electric current can be reduced, smooth operational feeling cannot be provided to users, i.e., the operability is reduced.

The present invention has been made in view of the above problems, and an object thereof is to provide an electronic device and a method of outputting detected information, both of which can reduce consumption of electric current without losing operability.

### Solution to Problem

In order to achieve the object, an electronic device of the present invention is configured to be an electronic device including: a detection section for sequentially outputting, at a first cycle, coordinate information that is information on a position of coordinates on a detection surface, the position of the coordinates being of a detection object detected on the detection surface; a detected information output section for (A) sequentially generating detected information having (i) the coordinate information which is sequentially outputted at the first cycle and (ii) information on time when the coordinate information is obtained and (B) sequentially outputting the detected information thus sequentially generated; and a timing control section for controlling a timing at which the detected information output section outputs the detected information, the detected information output section temporarily retaining, in accordance with control of the timing control section, first detected information selected from the detected information, the detected information output section sequentially outputting, at a second cycle which is larger than the first cycle, a detected information group having the first detected information and second detected information selected from the detected information other than the first detected information.

A method, of the present invention, of outputting detected information is configured to be a method of outputting detected information including the steps of: sequentially outputting, at a first cycle, coordinate information that is information on a position of coordinates on a detection surface, the position of the coordinates being of a detection object detected on the detection surface; sequentially generating detected information having (i) the coordinate information which is sequentially outputted at the first cycle and (ii) information on time when the coordinate information is obtained; sequentially outputting the detected information thus sequentially generated; temporarily retaining first detected information selected from the detected information; and sequentially outputting, at a second cycle which is larger than the first cycle, a detected information group having the first detected information and second detected information selected from the detected information other than the first detected information.

### Advantageous Effects of Invention

As described above, (i) the electronic device of the present invention includes the timing control section for controlling a timing at which the detected information output section outputs the detected information, (ii) the detected information output section temporarily retains, in accordance with the control of the timing control section, the first detected information selected from the detected information, and (iii) the detected information output section sequentially outputs, at the second cycle which is larger than the first cycle, the detected information group having the first detected information and the second detected information selected from the detected information other than the first detected information.

Further, according to the method of the present invention, the first detected information selected from the detected information is temporarily retained, and the detected information group having the first detected information and the second detected information selected from the detected information other than the first detected information is sequentially outputted at the second cycle larger than the first cycle.

It is therefore possible to provide an electronic device and a method of outputting detected information, both of which can reduce consumption of electric current without losing operability.

### BRIEF DESCRIPTION OF DRAWINGS

FIG. 1 is a block diagram illustrating a partial configuration of an inner configuration included in an electronic device of the present invention.

FIG. 2 is a block diagram illustrating an inner configuration of a framework of an electronic device of the present invention.

FIG. 3 is a flowchart showing processes performed in a framework of the present invention.

FIG. 4 is a view illustrating a flow in which information on an input operation by a user, which has been detected in a touch panel module of an electronic device of the present invention, is notified to an application at a cycle of 1/60 sec.

FIG. 5 is a view illustrating a flow in which information on an operation by a finger of a user, which has been detected in a touch panel module of an electronic device of the present invention, is notified to an application at a cycle of 1/30 sec.

FIG. 6 is a view illustrating a touch event notified in response to an input operation by a user. (a) of FIG. 6 illustrates a figure as an input operation to a touch panel, and (b) of FIG. 6 illustrates, on a two-dimensional plane, touch events notified to an application in response to the input operation of (a) of FIG. 6 with reference to this example.

FIG. 7 is a view illustrating a flow in which information on an input operation by a user, which has been detected in a touch panel module of a conventional electronic device, is notified to an application.

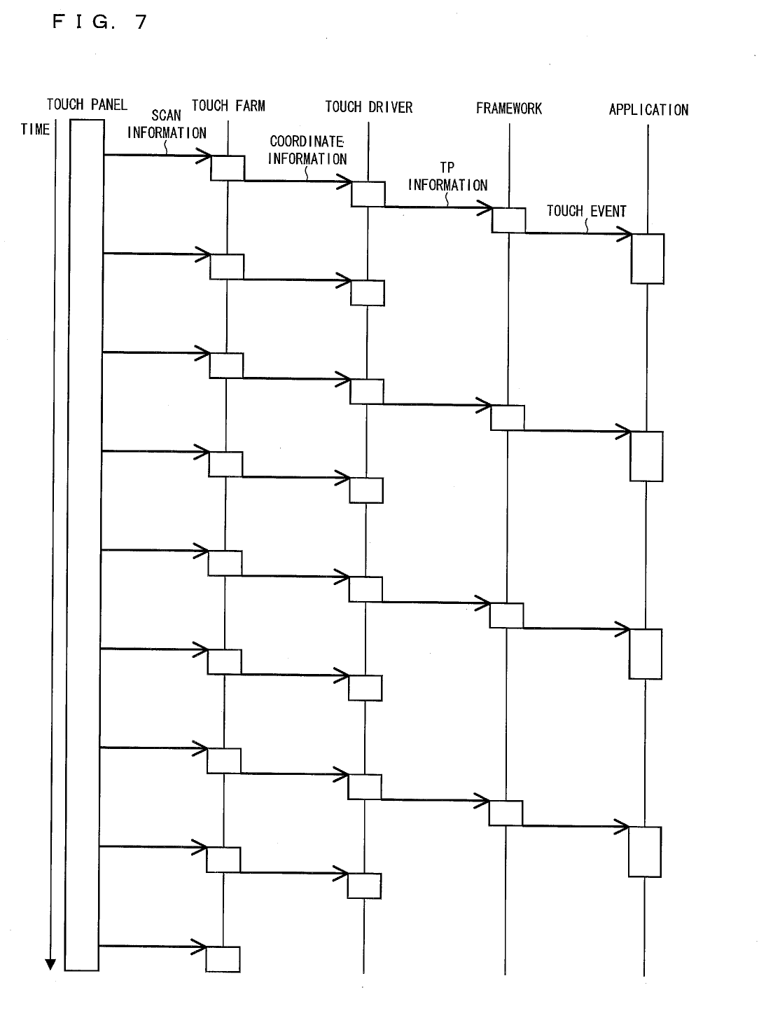

FIG. 8 is a view illustrating a touch event notified in response to an input operation by a user. (a) of FIG. 8 illustrates a figure as the input operation to a detection surface of a touch panel module, (b) of FIG. 8 illustrates, on a two-dimensional plane, touch events which have been notified to the application at a cycle of 1/60 sec. in response to the input operation of (a) of FIG. 8, and (c) of FIG. 8 illustrates, on a two-dimensional plane, touch events which have been notified to the application at a cycle of 1/30 sec. in response to the input operation of (a) of FIG. 8.

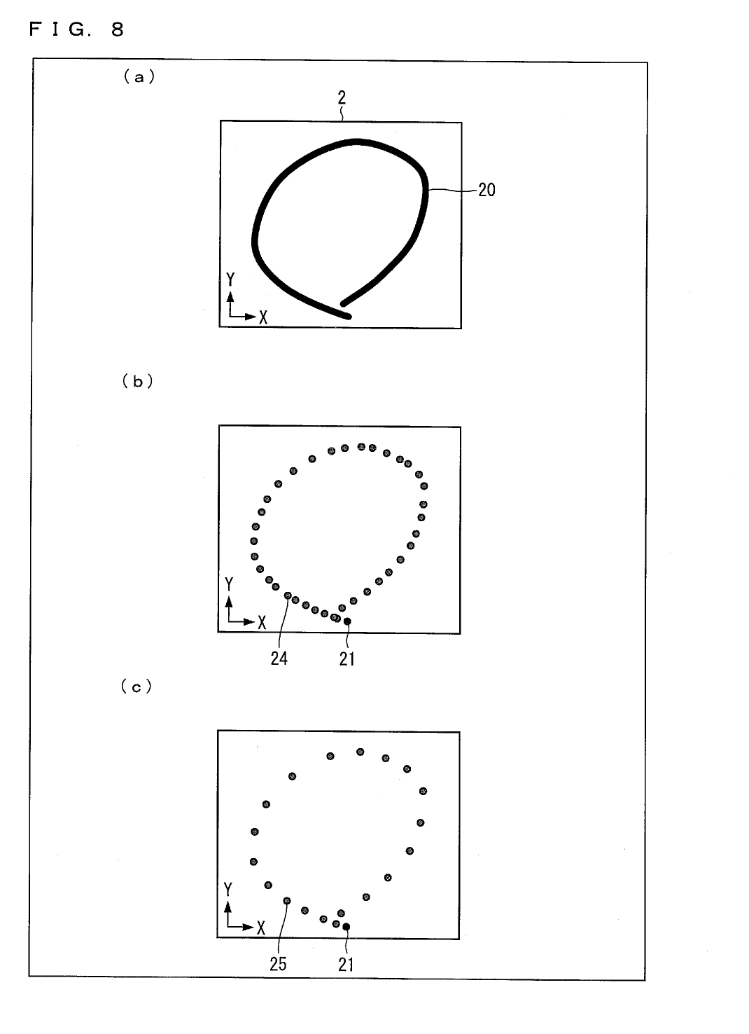

### DESCRIPTION OF EMBODIMENTS

### Embodiment

The following description will discuss an embodiment of the present invention in detail. An electronic device of the present invention includes a position detection section having a position detection function and is driven in response to an input operation (event) by a detection object detected by the position detection section, such as a finger of a user.

The electronic device further includes a display device, and it is preferable that a user can directly input an operation to a display screen.

As the display device, an active matrix liquid crystal display device can be used, for example. As the position detection section (detection section), a touch panel module, touch pad, mouse, or the like can be used.

In the following description, the electronic device includes an active matrix liquid crystal display device as the display device and a capacitance-type touch panel module as the position detection section on a display surface of the liquid crystal display device.

<Electronic Device>

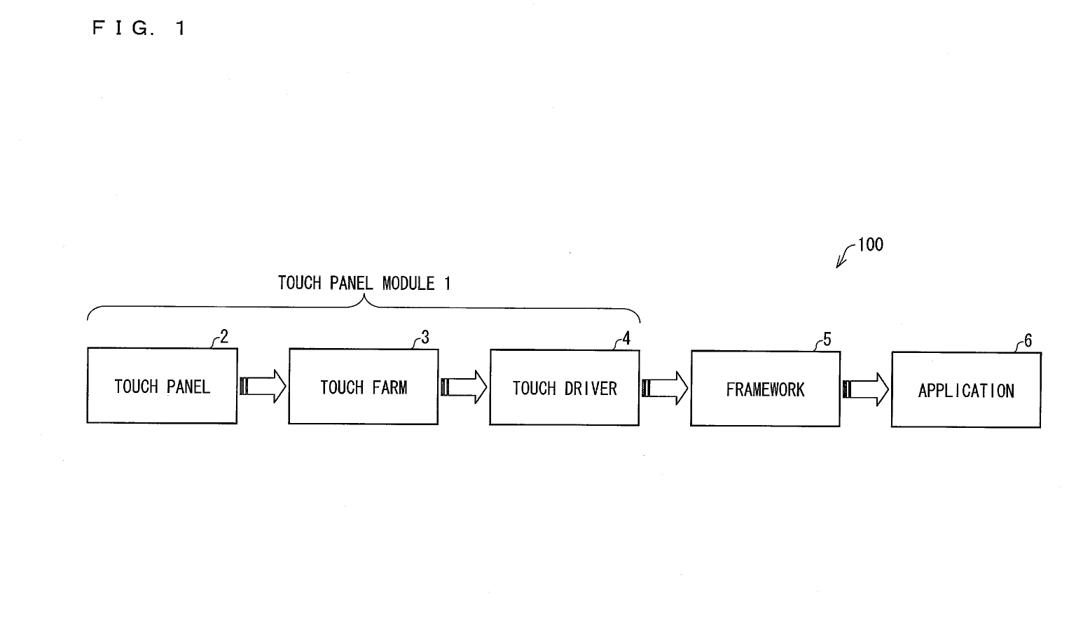

FIG. 1 is a block diagram illustrating a partial configuration of an inner configuration included in an electronic device 100 of the present invention.

As illustrated in FIG. 1, the electronic device 100 of the present invention includes a touch panel module 1, a framework 5 (application framework, detected information output section), and an application 6 (application software).

The electronic device 100 of the present invention has two touch event notification modes, i.e., a normal mode and an electric-current consumption reduction mode in accordance with a cycle in which a touch event is notified to the application 6 from the framework 5.

The cycle in which the touch event is notified is larger in the electric-current consumption reduction mode than in the normal mode.

The touch panel module 1 includes a touch panel 2, a touch farm 3, and a touch driver 4.

The touch panel 2 is hardware, and constitutes a detection surface of the touch panel module 1.

A capacitance of an electrode included in the touch panel 2 is changed by a finger (detection object) of a user contacting or approaching the detection surface of the touch panel 2.

By sequentially detecting change in the capacitance (scan information) at a predetermined cycle, the touch farm 3 generates coordinate information which is information on a position of coordinates where a finger has, for example, touched in the touch panel 2. A cycle in which the touch farm 3 sequentially detects change in capacitance is not limited.

The touch farm 3 sequentially inputs the coordinate information thus generated to the touch driver 4. The touch farm 3 may output information on a pressure of the detection object to the touch panel 2 together with the coordinate information.

The touch driver 4 sequentially generates touch panel information (hereinafter, TP information) having the coordinate information and information on time when each piece of the coordinate information has been obtained, and sequentially inputs the TP information to the framework 5. The touch driver 4 may also output information on the number of detection objects detected in the touch panel 2. That is, the touch driver 4 may output information on by how many fingers of a user an input operation is performed.

The framework 5 receives, as TP information, an event which is an operation inputted to the touch panel 2 by a finger of a user. By adding time information to coordinate information included in the TP information, the framework 5 generates a touch event (detected information) and inputs (notifies) the touch event to the application 6.

That is, the touch event has the coordinate information to which the time information on when the coordinate information was obtained has been added.

The application 6 obtains an event added by a user to the touch panel module 1 on the basis of the touch event, and performs a process in response to the event.

<Block Diagram of Framework>

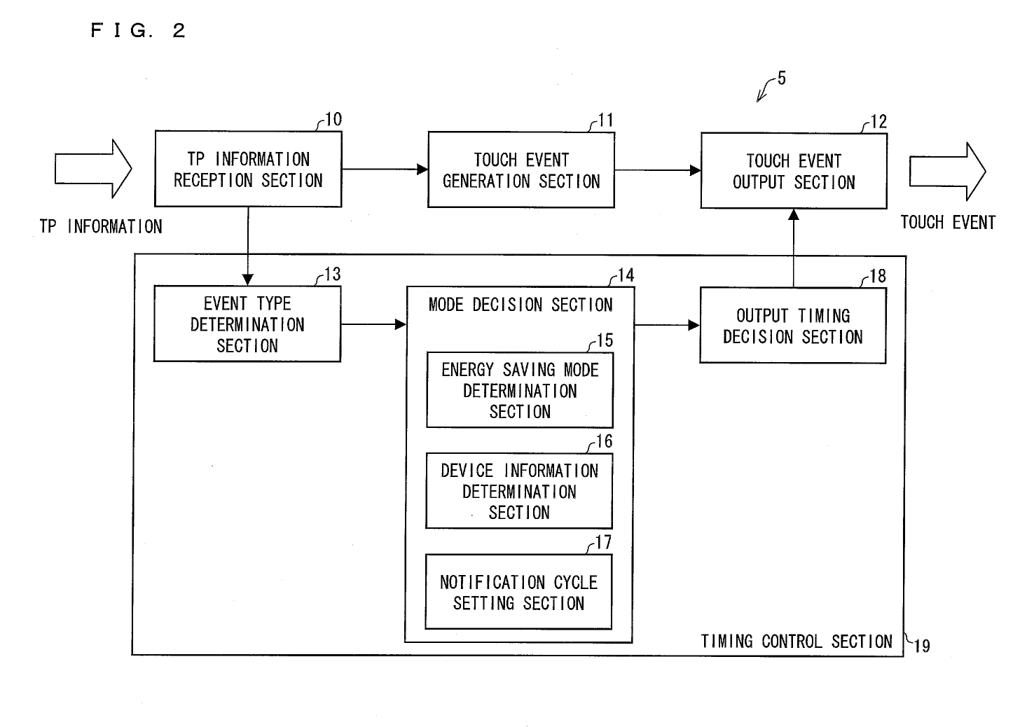

The following description will discuss the framework 5 in detail with reference to FIG. 2. FIG. 2 is a block diagram illustrating an inner configuration of the framework 5.

The framework 5 includes a TP information reception section 10, and the TP information sequentially outputted by the touch driver 4 is sequentially inputted to the framework 5 via the TP information reception section 10.

The TP information received by the TP information reception section 10 is sequentially inputted to a touch event generation section 11 and to an event type determination section 13.

The touch event generation section 11 generates a touch event on the basis of (i) coordinate information and (ii) time information on when the coordinate information has been obtained, which coordinate information and time information are included in the TP information. That is, the touch event generation section 11 adds, to the coordinate information, the time information on when the coordinate information has been obtained. The touch event generation section 11 may process (edit) data of the touch event with a well-known method so that the application 6 can easily process the touch event.

The touch event generation section 11 sequentially outputs the touch event thus generated to a touch event output section 12.

Based on the TP information received by the TP information reception section 10, the event type determination section 13 determines whether an event corresponding to the TP information is a touch-down event, a touch-move event, or a touch-up event.

The touch-down event is an operation in which a finger of a user is touched on the touch panel 2, and the touch-move event is an operation in which a finger of a user is moved on the touch panel 2, and the touch-up event is an operation in which a finger of a user is moved away from the touch panel 2.

For example, it is possible to determine whether an event is a touch-down event or a touch-up event on the basis of change in pressure of a finger to the touch panel 2. It is also possible to determine that an event is a touch-move event by comparing coordinate information in certain TP information with another coordinate information in TP information which has been received at a previous timing. Information on an event type thus determined is inputted to a mode determination section 14.

The mode determination section 14 includes an energy saving mode determination section 15, a device information determination section 16, and a notification cycle setting section 17.

The energy saving mode determination section 15 receives, from a user, an instruction about whether an energy saving setting is ON or OFF.

When there are a plurality of devices for inputting an event, the device information determination section 16 monitors information on a device to which the event corresponding to received TP information has been inputted. Specifically, the device information determination section 16 determines whether a device for inputting an event is the touch panel module 1 or a mouse.

The notification cycle setting section 17 sets a cycle in which the touch event is notified to the application 6 from the framework 5 on the basis of the information on the event type, ON/OFF of the energy saving setting, and device information. An output cycle of the touch event thus set is inputted to an output timing decision section 18.

The output timing decision section 18 outputs, on the basis of the output cycle of the touch event thus set, a timing signal to the touch event output section 12 at a timing at which the touch event should be outputted.

When the timing signal is inputted, the touch event output section 12 notifies, to the application 6, the touch event inputted from the touch event generation section 11. That is, the timing signal defines a timing at which the touch event output section 12 outputs the touch event.

The touch event output section 12 retains the touch event inputted from the touch event generation section 11 until the timing signal is inputted. In other words, the touch event output section 12 holds output of the touch event.

The touch event output section 12 notifies the touch event to the application 6 at a cycle at which the output timing decision section 18 outputs the timing signal.

As described above, the event type determination section 13, the mode determination section 14, and the output timing decision section 18 constitute a timing control section 19 and control a timing at which the touch event is outputted.

<Flow of Processes of Framework>

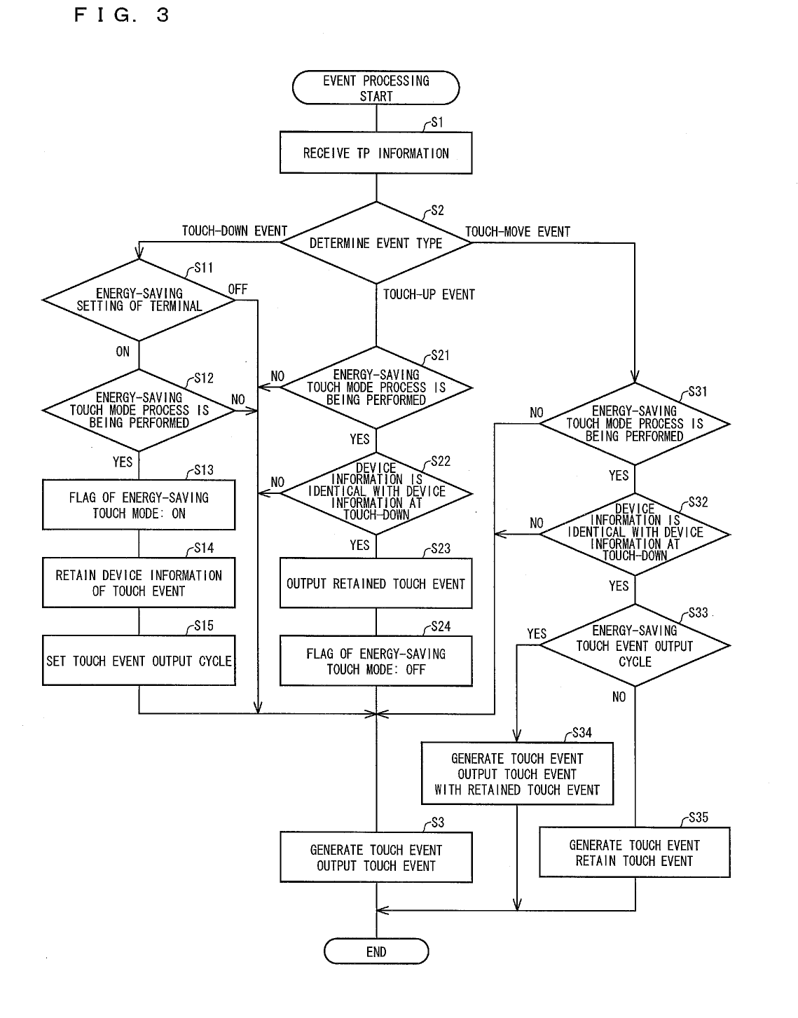

The following description will discuss processes in the framework 5 in detail with reference to FIG. 3. FIG. 3 is a flowchart showing processes performed in the framework 5.

The processes shown in the flowchart are sequentially performed every time when TP information is inputted to the framework 5.

First, the TP information reception section 10 receives TP information (S1).

Next, the event type determination section 13 determines whether an event corresponding to the TP information thus received is a touch-down event, a touch-move event, or a touch-up event (S2).

(Touch-Down Event)

In a case where a user touches the touch panel, an event type is a touch-down event.

In this case, as a next step, the energy saving mode determination section 15 determines whether the energy saving setting of a user setting is ON or OFF (S11). In a case where the energy saving setting of the user setting is OFF, the touch event generation section 11 generates a touch event, and the touch event output section 12 notifies the touch event to the application 6 (S3).

Meanwhile, in a case where the energy saving setting of the user setting is ON, it is determined whether or not an energy-saving touch mode process is actually performed when the TP information is inputted (S12).

In a case where the energy-saving touch mode process is actually performed when the TP information is inputted, a flag of the energy-saving touch mode process is turned ON (S13). Then, device information corresponding to the TP information thus inputted is retained by the device information determination section (S14). Thereafter, the notification cycle setting section 17 sets a cycle in which the touch event is outputted (S15). After that, the notification cycle setting section 17 generates a touch event, and the touch event output section 12 notifies the touch event to the application 6 (S3).

Note that, in S12, in a case where it is determined that the energy-saving touch mode process is not performed when the TP information is inputted, the touch event generated by the touch event generation section 11 is directly notified to the application 6 (S3).

(Touch-Move Event)

After a finger of a user is touched down on the touch panel 2 and then is moved on the touch panel 2, a determination result of an event type in S2 is a touch-move event.

In this case, as a next step, it is determined whether or not the energy-saving touch mode process is actually performed when the TP information is inputted (S31).

Then, device information when TP information is inputted is obtained, and it is determined whether or not the device information is identical with the device information when the TP information of the touch-down event is inputted (S32).

In a case where it is determined that the energy-saving touch mode process is not performed in S31, or in a case where it is determined that the device information when the TP information is inputted is different from the device information when the TP information of the touch-down event is inputted in S32, the touch event notification mode is a normal mode.

In a case where the touch event notification mode is the normal mode, the touch event generation section 11 generates a touch event, and notifies the touch event to the application 6 (S3).

Meanwhile, in a case where it is determined that (i) the energy-saving touch mode process is performed in S31 and (ii) the device information when the TP information is inputted is identical with the device information when the TP information of the touch-down event is inputted in S32, the touch event notification mode is an electric-current consumption reduction mode.

In a case where the touch event notification mode is the electric-current consumption reduction mode, the output timing decision section 18 determines whether or not the touch event is at an energy-saving touch event notification timing (S33).

In a case where the touch event is not at the energy-saving touch event notification timing, output of the touch event is held (S35). That is, the touch event output section 12 retains the touch event.

In a case where the touch event is at the energy-saving touch event notification timing in S33, the touch event output section 12 notifies, to the application 6, the touch event together with the touch event retained by the touch event output section 12 (S34). That is, the touch event output section 12 notifies the two touch events together to the application 6.

(Touch-Up Event)

In a case where a finger of a user is moved away from the touch panel 2 after a finger has been touched down on the touch panel 2, a determination result of an event type in S2 is a touch-up event.

In this case, as a next step, it is determined whether or not the energy-saving touch mode process is actually performed when the TP information is inputted (S21).

Then, device information when TP information is inputted is obtained, and it is determined whether or not the device information is identical with the device information when the TP information of the touch-down event is inputted (S22).

In a case where it is determined that the device information when the TP information is inputted is identical with the device information when the TP information of the touch-down event is inputted, the touch event retained by the touch event output section 12 is notified to the application 6 (S23).

After that, the flag is turned OFF during the energy-saving touch mode process (S24), and a touch event is generated, and notified to the application 6 (S3).

### Examples

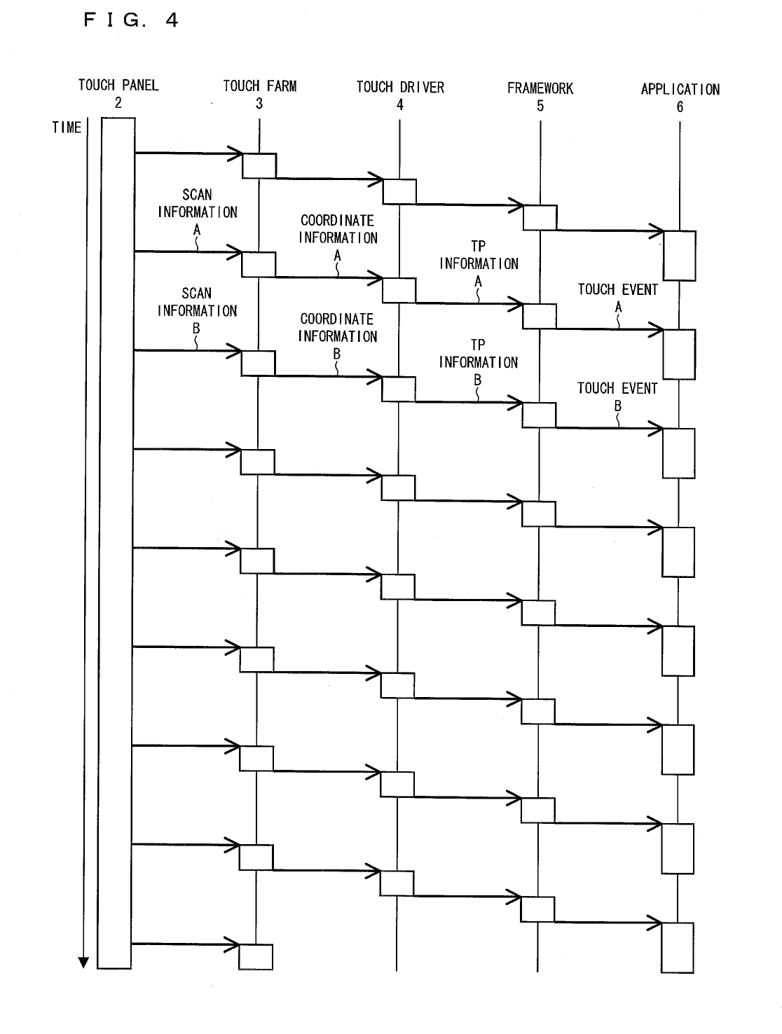

The following description will discuss an example of the electronic device 100 of the present invention with reference to FIGS. 4 to 6.

In the electronic device 100 of this example, the touch farm 3 sequentially obtains scan information of the touch panel 2 at a cycle of 1/60 sec. (first cycle), sequentially generates coordinate information, and sequentially outputs the coordinate information thus generated to the touch driver 4 at a cycle of 1/60 sec.

The touch driver 4 sequentially outputs TP information to the framework 5 at a cycle of 1/60 sec.

The framework 5 notifies the touch event to the application 6. At this time, the timing control section 19 controls a timing at which the touch event is outputted as described above.

The application 6 is set to have a maximum drawing cycle of 1/60 sec. That is, it is possible to process the touch event at a maximum frequency of 60 times per second.

Note that the electronic device 100 includes an active matrix liquid crystal display device, and a frame cycle (refresh cycle) at which an image displayed on a display surface of the liquid crystal display device is updated is set to 60 Hz.

By setting the refresh cycle of a displayed image of the liquid crystal display device to be identical with a cycle in which the touch event is notified as described above, followability of a finger of a user to the displayed image is increased. This makes it possible to improve operational feeling.

<Normal Mode>

FIG. 4 is a view illustrating a flow in which information on an input operation by a user, which has been detected in the touch panel module 1 of the electronic device 100, is notified to the application at a cycle of 1/60 sec. The arrows indicate flows of the information.

In the electronic device 100 of the present invention, in a case where the touch event notification mode is a normal mode, the touch event is notified to the application on the basis of the flow shown in FIG. 4.

The touch farm 3 obtains scan information A and scan information B at a time interval of 1/60 sec. (at a cycle of 1/60 sec.). Then, the touch farm 3 generates coordinate information A based on the scan information A and coordinate information B based on the scan information B, and inputs, to the touch driver 4, both the coordinate information A and the coordinate information B at a time interval of 1/60 sec.

The touch driver 4 generates TP information A based on the coordinate information A and TP information B based on the coordinate information B, and inputs, to the framework 5, both the TP information A and the TP information B at a time interval of 1/60 sec.

The framework 5 generates a touch event A based on the TP information A and a touch event B based on the TP information B, and notifies, to the application 6, both the touch event A and the touch event B at a time interval of 1/60 sec.

In this case, the application 6 performs drawing update at a cycle of 1/60 sec. in response to an input of the touch event and recognizes an input operation by a user. Therefore, it is possible to perform a process in response to the input operation by the user.

<Low Electric-Current Consumption Mode>

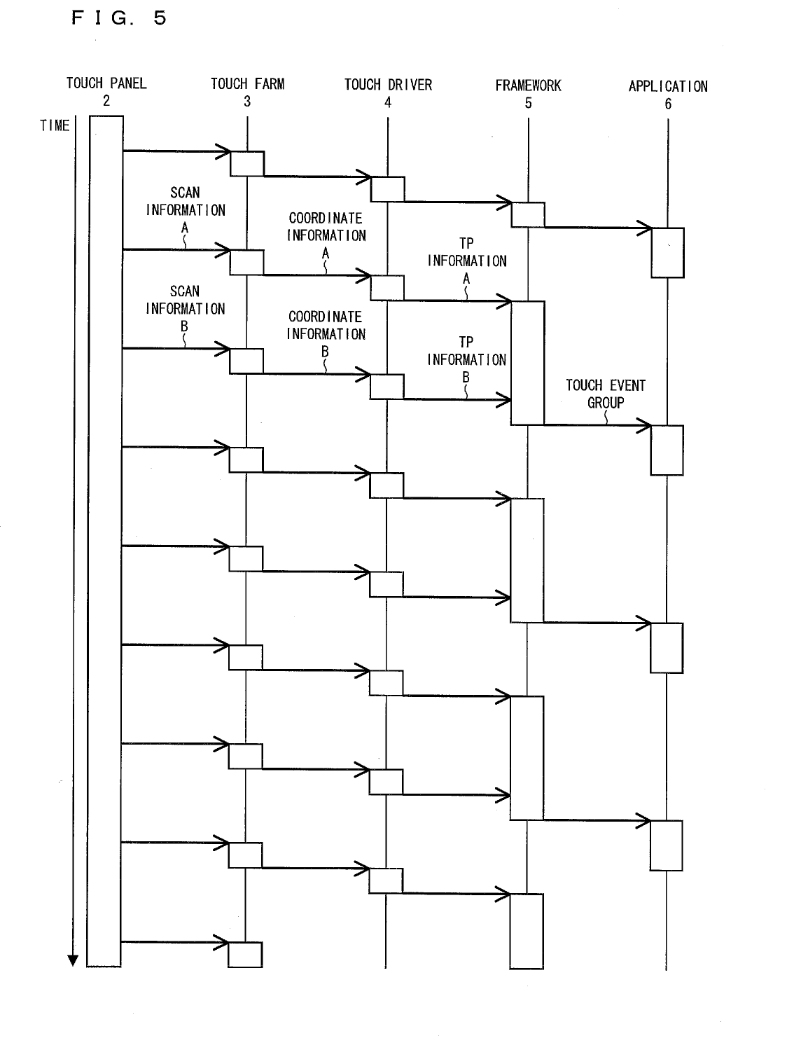

FIG. 5 is a view illustrating a flow in which information on an operation by a finger of a user, which has been detected in the touch panel module 1 of the electronic device 100, is notified to the application 6 at a cycle of 1/30 sec. The arrows indicate flows of the information.

In the electronic device 100 of the present invention, in a case where the touch event notification mode is a low electric-current consumption mode, the touch event is notified to the application on the basis of the flow shown in FIG. 5.

The touch farm 3 obtains scan information A and scan information B at a time interval of 1/60 sec. Then, the touch farm 3 generates coordinate information A based on the scan information A and coordinate information B based on the scan information B, and inputs, to touch driver 4, both the coordinate information A and the coordinate information B at a time interval of 1/60 sec.

The touch driver 4 generates TP information A based on the coordinate information A and TP information B based on the coordinate information B, and inputs, to the framework 5, both the TP information A and the TP information B at a time interval of 1/60 sec.

The framework 5 generates a touch event A (first detected information) based on the TP information A and a touch event B (second detected information) based on the TP information B. Then, the framework 5 notifies, to the application 6, both the touch event A and the touch event B together as a touch event group (detected information group).

The touch event A is a touch event selected from a plurality of touch events. The touch event B is a touch event selected from a plurality of touch events other than the touch event A.

Note that the touch event group is outputted at a time interval of 1/30 sec. That is, the touch event group is notified to the application 6 at a cycle of 1/30 sec. (second cycle) which is double as large as the touch event notification cycle in the normal mode.

According to this method of outputting a touch event, the application 6 performs drawing update at a cycle of 1/30 sec. in response to an input of the touch event and recognizes an input operation by a user. Therefore, it is possible to perform a process in response to the input operation by the user.

This increases a cycle in which the application 6 performs drawing update, and therefore the number of times of drawing update per unit time period is reduced. This makes it possible to reduce consumption of electric current.

Each of the two touch events notified together as the touch event group has coordinate information of a user's finger with respect to the detection surface, to which coordinate information time information is added. Therefore, the application 6 can correctly recognize an input operation by a finger of a user on the basis of each touch event.

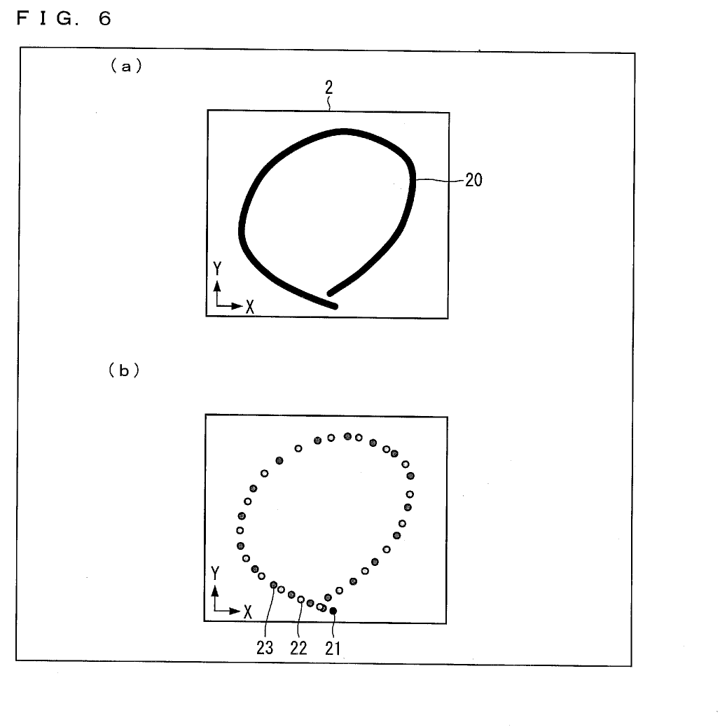

FIG. 6 is a view illustrating a touch event notified in response to an input operation by a user. (a) of FIG. 6 illustrates a FIG. 20 as an input operation to the touch panel 2, and (b) of FIG. 2 illustrates, on a two-dimensional plane, touch events notified to the application 6 in response to the input operation of (a) of FIG. 6.

As shown in (a) of FIG. 6, in a case where a user touches the touch panel 2 in such a manner as to draw the FIG. 20 having a substantially oval shape, the touch event shown in (b) of FIG. 6 is notified to the application 6.

In (b) of FIG. 6, of the two touch events included in the touch event group shown in FIG. 5, a touch event which has been temporarily retained in the framework 5 and then has been outputted, such as the touch event A, is denoted by a point 22. A touch event which has been outputted without having been retained in the framework 5, such as the touch event B, is denoted by a point 23.

A touch event denoted by the point 22 and a touch event which is denoted by the point 23 and is positioned in a point adjacent to the point 22 are notified to the application 6 at the identical timing.

Time information on when coordinate information is obtained is added to the coordinate information included in a touch event which has been retained temporarily in the framework 5. Therefore, the application 6 can correctly recognize the touch event.

Like this example, a measure of consumption of electric current can be performed by notifying a touch event group to the application 6 at a cycle ( 1/30 sec.) longer than a maximum drawing cycle ( 1/60 sec.) of the application 6.

Further, a moving speed of a finger at the time of a touch-move event can be correctly notified to the application 6 by notifying a touch event group including two touch events and notifying 60 touch events per second.

This makes it possible to perform a touch event control capable of performing an operation that a user expects. For example, in an input operation in which a list screen is scrolled by an operation of a touch-move event, it is possible to perform screen scrolling at a width that a user expects.

As described above, the electronic device 100 of the present invention can switch between the normal mode and the low electric-current consumption mode in accordance with setting of a user, and, even in a case where the low electric-current consumption mode is set, it is possible to maintain operability substantially equal to that in the normal mode.

Note that, in this example, there has been described an example where, by notifying two touch events together as a touch event group to the application 6, the touch event group is notified to the application 6 at a frequency of 30 times/sec. (30 times per second), however, the present invention is not limited thereto.

By notifying 3 touch events together as a touch event group to the application, the touch event group can be also notified to the application at a frequency of 20 times/sec.

Note, however, that, when a large number of touch events are notified together, there occurs a time difference between a time when a user inputs an operation and a time when the application recognizes an event, and therefore operational feeling may be lost. Therefore, it is preferable that a notification cycle in the normal mode be 1/60 sec. and a notification cycle in the low electric-current consumption mode be 1/30 sec.

### Summary of Embodiment

In order to achieve the object, an electronic device of the present invention is configured to be an electronic device including: a detection section for sequentially outputting, at a first cycle, coordinate information that is information on a position of coordinates on a detection surface, the position of the coordinates being of a detection object detected on the detection surface; a detected information output section for (A) sequentially generating detected information having (i) the coordinate information which is sequentially outputted at the first cycle and (ii) information on time when the coordinate information is obtained and (B) sequentially outputting the detected information thus sequentially generated; and a timing control section for controlling a timing at which the detected information output section outputs the detected information, the detected information output section temporarily retaining, in accordance with control of the timing control section, first detected information selected from the detected information, the detected information output section sequentially outputting, at a second cycle which is larger than the first cycle, a detected information group having the first detected information and second detected information selected from the detected information other than the first detected information.

According to the configuration, the detected information output section can sequentially output multiple pieces of detected information together thanks to the timing control section. This makes it possible to output the multiple pieces of detected information at a larger cycle, as compared with a case where the multiple pieces of detected information are sequentially and individually outputted.

Further, the detected information output section can generate the detected information based on the coordinate information and can output the detected information without thinning the coordinate information generated in the detection section.

By notifying an operation inputted by a user to the detection section on the basis of the detected information outputted from the detected information output section, it is possible to reduce consumption of electric current without reducing operability of the user.

The electronic device of the present invention may be configured so that the second cycle is double as large as the first cycle.

With this configuration, it is possible to reduce consumption of electric current without reducing operational feeling of a user.

The electronic device of the present invention may be configured so that an image displayed via the detection surface is updated in accordance with the detected information, and the first cycle is identical with a frame cycle that is a cycle in which the image is updated.

With this configuration, it is possible to output the detected information in accordance with a refresh cycle of the image. This makes it possible to increase followability of a finger of a user to a displayed image and to improve operational feeling of the user.

The electronic device of the present invention may be configured so that the timing control section outputs a timing signal for defining a timing at which the detected information output section outputs the detected information, when the timing control section outputs the timing signal at the second cycle, the detected information output section sequentially outputs the detected information group at the second cycle.

With this configuration, it is possible to control, in accordance with a timing at which the timing control section outputs the timing signal, a timing at which the detected information output section outputs the detected information.

The electronic device of the present invention may be configured so that the detection section sequentially outputs the coordinate information at a cycle of 1/60 sec., and the detected information output section (i) temporarily retains, in accordance with the control of the timing control section, the first detected information selected from the detected information, and (ii) sequentially outputs, at a cycle of 1/30 sec., the detected information group having the first detected information and the second detected information selected from the detected information other than the first detected information.

With this configuration, by notifying an operation inputted by a user to the detection section on the basis of the detected information outputted from the detected information output section, it is possible to reduce consumption of electric current without reducing operability of the user.

A method, of the present invention, of outputting detected information is configured to be a method of outputting detected information including the steps of: sequentially outputting, at a first cycle, coordinate information that is information on a position of coordinates on a detection surface, the position of the coordinates being of a detection object detected on the detection surface; sequentially generating detected information having (i) the coordinate information which is sequentially outputted at the first cycle and (ii) information on time when the coordinate information is obtained; sequentially outputting the detected information thus sequentially generated; temporarily retaining first detected information selected from the detected information; and sequentially outputting, at a second cycle which is larger than the first cycle, a detected information group having the first detected information and second detected information selected from the detected information other than the first detected information.

With this configuration, by sequentially outputting multiple pieces of detected information together, it is possible to output the multiple pieces of detected information at a larger cycle, as compared with a case where the multiple pieces of detected information are sequentially and individually outputted.

Further, it is possible to generate the detected information based on the coordinate information and output the detected information without thinning the coordinate information thus generated.

By notifying an operation inputted by a user to the detection section on the basis of the detected information thus outputted, it is possible to reduce consumption of electric current without reducing operability of the user.

The present invention is not limited to the description of the embodiments above, and can be modified in numerous ways by a skilled person as long as such modification falls within the scope of the claims. An embodiment derived from a proper combination of technical means disclosed in different embodiments is also encompassed in the technical scope of the present invention.

### INDUSTRIAL APPLICABILITY

The present invention is applicable to an electronic device having a position detection function.

### REFERENCE SIGNS LIST

1: Touch panel module (detection section)
5: Framework (detected information output section)
19: Timing control section
100: Electronic device

1. An electronic device, comprising:
a detection section for sequentially outputting, at a first cycle, coordinate information that is information on a position of coordinates on a detection surface, the position of the coordinates being of a detection object detected on the detection surface;
a detected information output section for (A) sequentially generating detected information having (i) the coordinate information which is sequentially outputted at the first cycle and (ii) information on time when the coordinate information is obtained and (B) sequentially outputting the detected information thus sequentially generated; and
a timing control section for controlling a timing at which the detected information output section outputs the detected information,
the detected information output section temporarily retaining, in accordance with control of the timing control section, first detected information selected from the detected information,
the detected information output section sequentially outputting, at a second cycle which is larger than the first cycle, a detected information group having the first detected information and second detected information selected from the detected information other than the first detected information.

2. The electronic device as set forth in claim 1,
wherein the second cycle is double as large as the first cycle.

3. The electronic device as set forth in claim 1, wherein an image displayed via the detection surface is updated in accordance with the detected information, and
the first cycle is identical with a frame cycle that is a cycle in which the image is updated.

4. The electronic device as set forth in claim 1, wherein the timing control section outputs a timing signal for defining a timing at which the detected information output section outputs the detected information,
when the timing control section outputs the timing signal at the second cycle, the detected information output section sequentially outputs the detected information group at the second cycle.

5. The electronic device as set forth in claim 1, wherein the detection section sequentially outputs the coordinate information at a cycle of 1/60 sec., and
the detected information output section (i) temporarily retains, in accordance with the control of the timing control section, the first detected information selected from the detected information, and (ii) sequentially outputs, at a cycle of 1/30 sec., the detected information group having the first detected information and the second detected information selected from the detected information other than the first detected information.

6. A method of outputting detected information, comprising the steps of:
sequentially outputting, at a first cycle, coordinate information that is information on a position of coordinates on a detection surface, the position of the coordinates being of a detection object detected on the detection surface;
sequentially generating detected information having (i) the coordinate information which is sequentially outputted at the first cycle and (ii) information on time when the coordinate information is obtained;
sequentially outputting the detected information thus sequentially generated;
temporarily retaining first detected information selected from the detected information; and
sequentially outputting, at a second cycle which is larger than the first cycle, a detected information group having the first detected information and second detected information selected from the detected information other than the first detected information.
